(19) United States
(12) Patent Application Publication
(10) Pub. No.: US 2012/0253748 A1
(43) Pub. Date: Oct. 4, 2012

(54) WIRELESS ELECTRONIC DEVICE TESTING METHOD

(75) Inventors: Shi-Jie Zhang, Taipei (TW); Tsung-Wen Hsueh, Taipei (TW)

(73) Assignee: Primax Electronics Ltd., Taipei (TW)

(21) Appl. No.: 13/156,759

(22) Filed: Jun. 9, 2011

(30) Foreign Application Priority Data
Apr. 1, 2011 (TW) 100111565

(51) Int. Cl. G06F 15/00

(52) U.S. Cl. 702/189

(57) ABSTRACT

A wireless electronic device testing method utilizes a computer to test a wireless electronic device. The wireless electronic device testing method includes the following steps. Firstly, at least one wireless signal is received. Then, a device type of the wireless electronic device is recognized according to the wireless signal. Then, a judging step is performed to judge whether the device type of the wireless electronic device complies with a preset device type. If the judging condition is satisfied, the wireless signal is converted into a control code. Then, another judging step is performed to judge whether the control complies with a preset control code. Afterwards, a judging result is shown. In this testing method, the wireless signal is converted into a control code by a control program, and the control code is directly transmitted to a test program to be tested. As a consequence, the testing efficacy is enhanced.

### FIELD OF THE INVENTION

The present invention relates to a testing method, and more particularly to a wireless electronic device testing method.

### BACKGROUND OF THE INVENTION

Generally, after a wireless electronic device is produced, a testing method is implemented to realize whether the wireless electronic device can be accurately operated. Please refer to FIG. 1. FIG. 1 is a schematic functional block diagram illustrating a computer and a wireless electronic device to be tested by the computer according to a conventional testing method. The conventional testing method for testing the wireless electronic device is executed by a computer 10. The subject to be tested is a wireless electronic device 20. The computer 10 comprises a first wireless transmission module 11 and a monitor 13. The wireless electronic device 20 has a second wireless transmission module 21 for transmitting a wireless signal. For example, the wireless electronic device 20 is a wireless input device, a wireless audio device or a wireless communication device. In the context, the wireless electronic device 20 is illustrated by referring to a wireless mouse. Nevertheless, the wireless electronic device 20 is not limited to the wireless mouse.

Moreover, a first wireless transmission module driver 120, a virtual device driver 121, a device driver 122, a filter driver 123 and a testing program 124 are stored in the computer 10. The virtual device driver 121 and the filter driver 122 are built-in drivers of Windows® operating systems. The virtual device driver 121 is used to emulate a wireless electronic device 20 which is not physically in communication with the computer 10. In addition, the virtual device driver 121 is also used to assign the wireless signal that is generated by the wireless electronic device 20. The filter driver 123 is used to intercept and lock the request of file systems or disc drivers.

FIG. 2 schematically illustrates a flowchart of a conventional testing method. Firstly, in the step S10, the wireless signal from the wireless electronic device 20 is received by the first wireless transmission module 11 of the computer 10. The wireless signal is then transmitted to the first wireless transmission module driver 120 to be processed.

After the wireless signal is received by the first wireless transmission module driver 120, the wireless signal is transmitted to the virtual device driver 121 (Step S11).

After the wireless signal is received by the virtual device driver 121, a device type of the wireless electronic device 20 (e.g. a mouse type) is recognized according to the wireless signal, and then the wireless signal is transmitted to the device driver 122 corresponding to the device type (e.g. a mouse driver) (Step S12).

After the wireless signal is received by the device driver 122, the wireless signal is converted into a control code, and then the control code is transmitted to a core of the operating system to be computed (Step S13).

In accordance to the normal operating process of the computer 10, the computed control code is then assigned to a corresponding application program to generate a corresponding instruction action. However, for the back-end testing process of the production line, it is important to introduce the control code into the testing program 124 for judgment instead of allowing the computed control code to generate a corresponding instruction action. Consequently, after the step S13 is performed, the control code is intercepted by the filter driver 123, and then the control code is transmitted to the testing program 124 (Step S14).

Then, the testing program 124 judges whether the content of the control code complies with a preset control code (Step S15). If the judging condition is satisfied, the wireless electronic device 20 passes the test. Whereas, if the judging condition is satisfied, the wireless electronic device 20 fails to pass the test.

Then, a judging result is shown on the monitor 13 to indicate whether the wireless electronic device 20 passes the test of the testing program 124 (Step S16).

Afterwards, the device driver 122 is removed from the computer 10, and the testing process is ended (Step S17).

From the above discussions, it is found that the conventional testing method for testing the wireless electronic device 20 needs to additionally install the device driver 122 corresponding to the wireless electronic device 20. By the device driver 122, the wireless signal is converted into a control code that is tested by the testing program 124. However, the basic function of the device driver 122 is originally performed to drive the wireless electronic device 20. After the wireless signal is successfully converted into the control code, the control code fails to be transmitted to the testing program 124. Consequently, the control code should be intercepted by the filter driver 123 and then transmitted to the testing program 124 to be tested. After the testing process is done, the device driver 122 should be removed from the computer 10. In other words, it is time-consuming to implement the conventional testing method. Moreover, the process of repeatedly installing and removing the device driver 122 may cause systematic instability of the computer 10 so as to crash the computer 10. Under this circumstance, the testing efficacy is largely reduced.

### SUMMARY OF THE INVENTION

The present invention provides a testing method for testing an electronic device in a time-saving manner.

In accordance with an aspect of the present invention, there is provided a wireless electronic device testing method for testing a wireless electronic device by a computer. The wireless electronic device testing method includes the following steps. Firstly, at least one wireless signal is received. Then, a device type of the wireless electronic device is recognized according to the wireless signal. Then, a judging step is performed to judge whether the device type of the wireless electronic device complies with a preset device type. If the device type of the wireless electronic device complies with the preset device type, the wireless signal is converted into a control code. Then, another judging step is performed to judge whether the control complies with a preset control code. Afterwards, a judging result is shown.

In an embodiment, the computer is operated in a wireless fidelity (Wi-Fi) transmission mode.

In an embodiment, the wireless electronic device is operated in a wireless fidelity (Wi-Fi) transmission mode.

In an embodiment, the preset device type is a mouse type.

In an embodiment, the wireless electronic device is a wireless mouse.

In an embodiment, the control code is a three-byte packet, wherein three bytes of the three-byte packet correspond to a key-pressing action, a horizontal displacement amount and a vertical displacement amount of the wireless electronic device, respectively.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a computer and a wireless electronic device to be tested by the computer according to a conventional testing method;

FIG. 2 schematically illustrates a flowchart of a conventional testing method;

FIG. 3 is a schematic functional block diagram illustrating a computer and a wireless electronic device used in a wireless electronic device testing method according to an embodiment of the present invention;

FIG. 4 schematically illustrates a flowchart of a wireless electronic device testing method according to an embodiment of the present invention; and

FIG. 5 schematically illustrates a judging result of the wireless electronic device testing method according to an embodiment of the present invention.

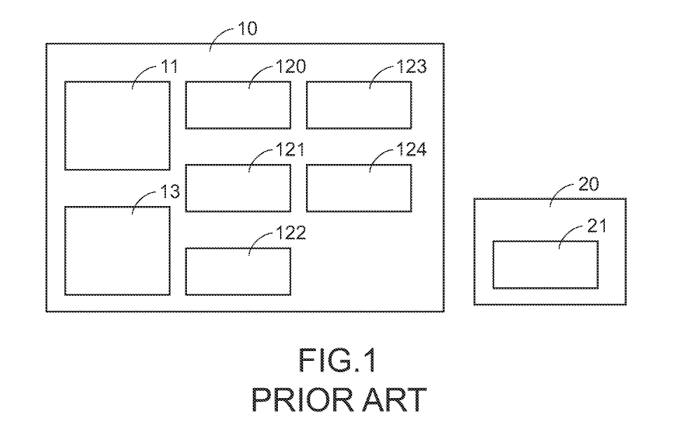

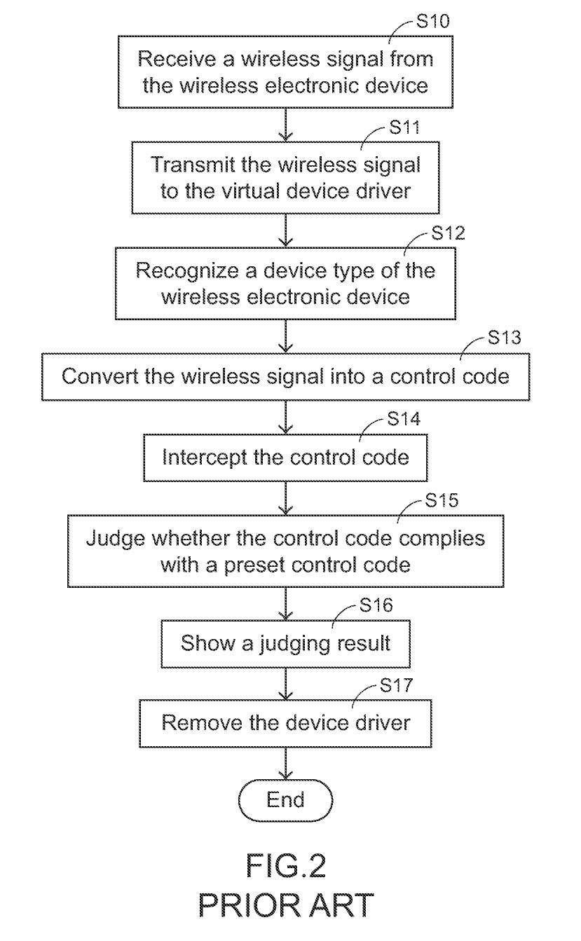

### DETAILED DESCRIPTION OF THE PREFERRED EMBODIMENT

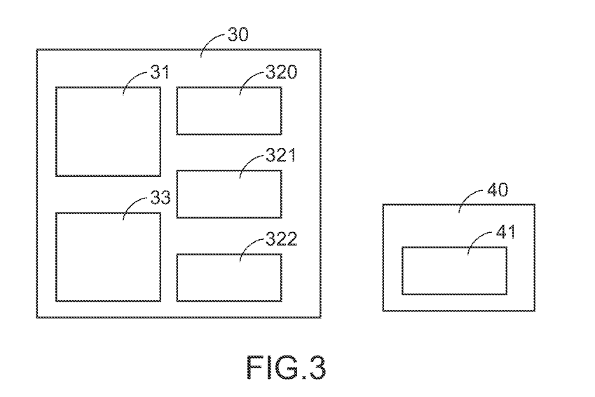

FIG. 3 is a schematic functional block diagram illustrating a computer and a wireless electronic device used in a wireless electronic device testing method according to an embodiment of the present invention. In FIG. 3, a computer 30 and a wireless electronic device 40 are shown. The computer 30 comprises a first wireless transmission module 31 and a monitor 33. The wireless electronic device 40 has a second wireless transmission module 41 for transmitting a wireless signal. For example, the wireless electronic device 40 is a wireless input device, a wireless audio device or a wireless communication device. In the context, the wireless electronic device 40 is illustrated by referring to a wireless mouse. Nevertheless, the wireless electronic device 40 is not limited to the wireless mouse.

Moreover, a first wireless transmission module driver 320, a control driver 321 and a testing program 322 are stored in the computer 30. In this embodiment, the first wireless transmission module 31 and the second wireless transmission module 41 are wireless fidelity (Wi-Fi) modules. In other words, the computer 30 and the wireless electronic device 40 are operated in wireless fidelity (Wi-Fi) modes. Alternatively, the wireless electronic device testing method of the present invention may be applied to other wireless transmission technologies. For example, the wireless electronic device testing method may be applied to a Bluetooth wireless transmission technology.

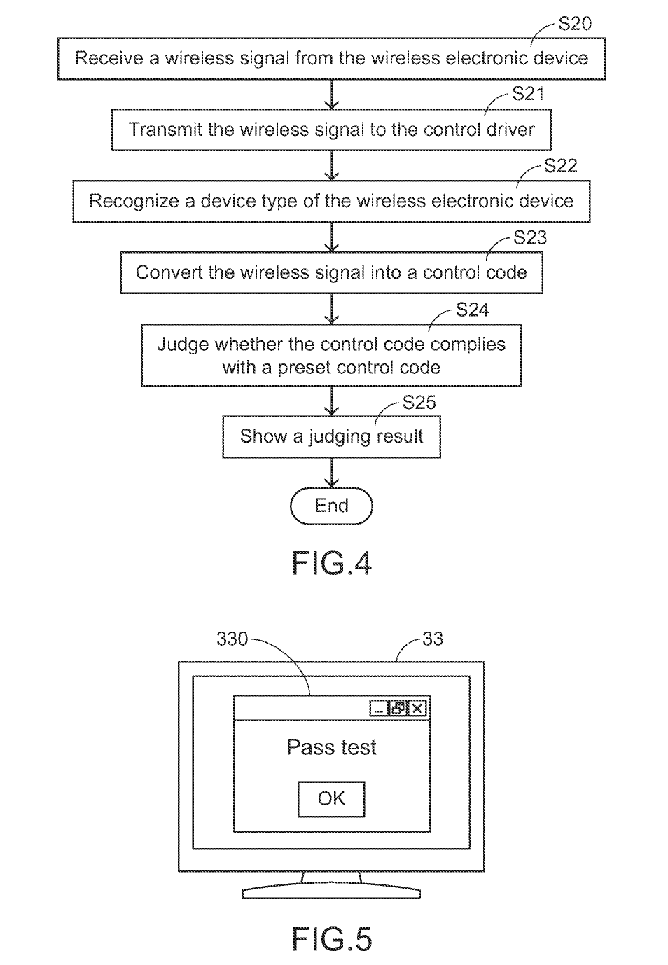

FIG. 4 schematically illustrates a flowchart of a wireless electronic device testing method according to an embodiment of the present invention. Firstly, in the step S20, the wireless signal from the wireless electronic device 40 is received by the first wireless transmission module 41 of the computer 30. The wireless signal is then transmitted to the first wireless transmission module driver 420 to be processed.

After the wireless signal is received by the first wireless transmission module driver 320, the wireless signal is transmitted to the control program 321 (Step S21).

After the wireless signal is received by the control program 321, a device type of the wireless electronic device 40 is recognized according to the wireless signal (Step S22). Then, the control program 321 judges whether the device type of the wireless electronic device 40 complies with a preset device type. For example, the preset device type is a mouse type. If the device type of the wireless electronic device 40 complies with the preset device type, the wireless signal is converted into a control code, and the control code is directly transmitted to the testing program 322 (Step 23).

Then, the testing program 322 judges whether the control code complies with a preset control code (Step S24). In this embodiment, the control code is a three-byte packet. The three bytes of the three-byte packet correspond to a key-pressing action, a horizontal displacement amount and a vertical displacement amount of the wireless electronic device 40, respectively. That is, the testing program 322 compares the three bytes of the preset control code with the three bytes of the control code. If the control code complies with the preset control code, the operations of the wireless electronic device 40 are normal, so that the wireless electronic device 40 passes the test. Whereas, if the control code does not comply with the preset control code, the operations of the wireless electronic device 40 are abnormal, and thus the wireless electronic device 40 fails to pass the test. The operating principles and detailed testing procedures of the testing program 322 are similar to those of the prior art, and are not redundantly described herein.

Then, a judging result is shown on the monitor 33 to indicate whether the wireless electronic device 40 passes the test of the testing program 322 (Step S25). Then, the testing process is ended without the need of removing any driver. Please refer to FIG. 5. FIG. 5 schematically illustrates a judging result of the wireless electronic device testing method according to an embodiment of the present invention. In this embodiment, the judging result is shown as an information window 330.

From the above description, in the wireless electronic device testing method of the present invention, the wireless signal is transmitted to the control program 321 through the first wireless transmission module 31, and then the device type is recognized to judge whether the device type of the wireless electronic device complies with a preset device type. If the device type complies with a preset device type, the wireless signal is converted into a control code. The control code is directly introduced into the testing program 321 to be tested. In such way, the time period for testing the wireless electronic device 40 is reduced. Moreover, since the process of repeatedly installing and removing the device driver 122 is omitted according the wireless electronic device testing method of the present invention, the possibility of causing systematic instability of the computer 10 or crash the computer 10 will be minimized. As a consequence, the testing efficacy is largely enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless electronic device testing method for testing a wireless electronic device by a computer, said wireless electronic device testing method comprising steps:
receiving at least one wireless signal;
recognizing a device type of said wireless electronic device according to said wireless signal;
judging whether said device type of said wireless electronic device complies with a preset device type, wherein if said device type of said wireless electronic device complies with said preset device type, said wireless signal is converted into a control code;
judging whether said control complies with a preset control code; and
showing a judging result.

2. The wireless electronic device testing method according to claim 1 wherein said computer is operated in a wireless fidelity (Wi-Fi) transmission mode.

3. The wireless electronic device testing method according to claim 1 wherein said wireless electronic device is operated in a wireless fidelity (Wi-Fi) transmission mode.

4. The wireless electronic device testing method according to claim 1 wherein said preset device type is a mouse type.

5. The wireless electronic device testing method according to claim 1 wherein said wireless electronic device is a wireless mouse.

6. The wireless electronic device testing method according to claim 1 wherein said control code is a three-byte packet, wherein three bytes of said three-byte packet correspond to a key-pressing action, a horizontal displacement amount and a vertical displacement amount of said wireless electronic device, respectively.
